(19) United States
(12) Patent Application Publication
(10) Pub. No.: US 2010/0182962 A1
(43) Pub. Date: Jul. 22, 2010

(54) DEVICE, METHOD AND SYSTEM FOR EXCHANGE OF INFORMATION BETWEEN MULTIPLE WIRELESS NETWORK GROUPS

(75) Inventors: Shih-Heng Cheng, Hsinchu (TW); Ching-Yao Huang, Hsinchu (TW)

Correspondence Address: EDWARDS ANGELL PALMER & DODGE LLP, P.O. BOX 55874, BOSTON, MA, 02205, US

(73) Assignee: NATIONAL CHIAO TUNG UNIVERSITY, Hsinchu (TW)

(21) Appl. No.: 12/398,442

(22) Filed: Mar. 5, 2009

(30) Foreign Application Priority Data
Jan. 21, 2009 (KR) 098102191

(51) Int. Cl. H04W 74/00

(52) U.S. Cl. 370/329

(57) ABSTRACT

Exchanging information between multiple wireless network groups is implemented by a wireless channel with a wide transmission range and a wireless channel with a narrow transmission range so as to predetermine data transmission schedule of each node of the multiple wireless network groups. Hence, a drawback of the prior art, that is, reduced transmission efficiency and increased power consumption due to collisions between packets of the multiple wireless network groups, is overcome.

### BACKGROUND OF THE INVENTION

1. Field of the Invention

The present invention relates generally to a device, a system and a method for exchanging data in wireless networks, and more particularly to a device, a system and a method for exchanging data between multiple wireless network groups so as to prevent packet collisions.

2. Description of Related Art

Wireless networks refer to network systems that wirelessly transmit data without the need of physical wires for connecting different nodes. But in a wireless network, packet collisions are the main reason for energy consumption. Particularly, energy consumption caused by packet collisions seriously affects the operating efficiency of a wireless body area network. In the prior art, transmission schedule information of wireless networks is exchanged with assistance of wired networks, or exchanged through direct contact between wireless network groups and common wireless network nodes, such that new transmission schedules can be formed to prevent packet collisions in the wireless networks. However, the use of wired networks decreases mobility of wireless networks. For a wireless network connected to a wired network through physical cables so as to exchanges information with another wireless network, it cannot be used outside a predetermined range and cannot be applied to networks with high mobility. Therefore, such a wireless network is not applicable to a wireless body area network. In addition, the method of combining wireless network groups through direct contact therebetween is also not applicable to a wireless body area network due to the following drawbacks:
(1) during the combination process, nodes at the network edge find each other through collisions, which consumes energy of the wireless body area network;
(2) during the combination process, collisions cause great reduction of bandwidth. If the reduction is greater than the minimum bandwidth requirement of the nodes, network disruption or collapse may occur, thereby leading to a serious loss of signals between the nodes;
(3) during the merging process of the network groups, merging information of the whole network must pass through the edge nodes first before being transmitted to nodes that can determine transmission schedules, such a process leads to additional bandwidth requirements and consumption of energy for controlling the transmission of information.

U.S. Pat. No. 5,313,465 discloses a method for merging wired networks through a wired backbone structure and discloses how to exchange information in two networks. However, packet collisions that occur during contact of wireless networks do not occur in such a wired backbone structure. U.S. Pat. No. 6,466,608 discloses a method for combining distributed Bluetooth networks, which is achieved by synchronization of frequency hopping. Since such a method needs direct contact of networks, packet collisions may occur in the combination process. U.S. Pat. No. 6,691,173 provides a method for combining wireless networks with assistance of wired networks or common wireless nodes. However, the use of the wired networks limits mobility of the wireless networks, and the use of the common wireless nodes results in direct contact of the wireless networks, which also leads to the problem of packet collisions during the combination process of the wireless networks. U.S. Pat. No. 6,975,613 discloses a method for combining two or more wireless networks and a bandwidth allocation function. Although the bandwidth allocation function prevents packet collisions and enhances the transmission efficiency, during the initial period of combination of the wireless networks, communication is achieved through direct contact. As a result, packet collisions may occur in this process.

According to the prior art, energy consumption in the current wireless network systems cannot meet the requirement of wireless body area networks. Therefore, there is a need to provide a device, a method and a system for preventing packet collisions between wireless network groups so as to decrease energy consumption of the wireless network systems such that the device and method can be applied to a wireless body area network requiring low energy consumption.

### SUMMARY OF THE INVENTION

According to the above drawbacks, the present invention provides a device, a method and a system for exchange of information between multiple wireless network groups, which decrease packet collisions and energy consumption of wireless network nodes and accordingly are applicable to wireless body area networks that have relatively lower energy demand compared with the conventional wireless networks.

According to one embodiment, the present invention provides a method for exchange of information between multiple wireless network groups, which comprises the steps of: (1) providing a first wireless network group and at least a second wireless network group, wherein each of the first and second wireless network groups include a central processing node and a plurality of network nodes; and (2) through a first channel with a first transmission range, the central processing node of the first wireless network group exchanging group information with the central processing node of the second wireless network group that has a same channel such that the central processing node of the first wireless network group communicates node information with the network nodes of the first wireless network group through a channel with a second transmission range according to the group information, wherein the first transmission range is greater than the second transmission range.

According to another embodiment of the present invention, a system for exchange of information between multiple wireless network groups is provided, which comprises: a first wireless network group with a central processing node and a plurality of network nodes; and at least a second wireless network group with a central processing node and a plurality of network nodes, wherein, through a channel with a first transmission range, the central processing node of the first wireless network group exchanges group information with the central processing node of the second wireless network group that has a same channel such that the central processing node of the first wireless network group communicates node information with the network nodes of the first wireless network group through a channel with a second transmission range according to the group information, the first transmission range being greater than the second transmission range.

The present invention further provides a device for exchange of information between multiple wireless network groups, which is applicable to a data exchange mechanism having a first wireless network group with a plurality of network nodes and at least a second wireless network group with a plurality of network nodes. The device comprises: a central processing node disposed in the first wireless network group for exchanging group information with the second wireless network group through a channel with a first transmission range and further communicating node information with the network nodes of the first wireless network group through a channel with a second transmission range, wherein the first transmission range is greater than the second transmission range.

As described above, the present invention utilizes a wireless channel with a wide transmission range and a wireless channel with a narrow transmission range to implement exchange of transmission schedule information between multiple wireless network groups, thereby predetermining the transmission schedule of each wireless node of the multiple wireless network groups so as to prevent packet collisions during data transmission between the wireless network groups. Accordingly, the power consumption of the nodes is decreased and the operating efficiency of the wireless network groups is increased.

### BRIEF DESCRIPTION OF DRAWINGS

FIG. 1 is a diagram showing wireless networks according to a first embodiment of the present invention;

FIG. 2 is a flow diagram showing a method for preventing packet collisions according to an embodiment of the present invention;

FIGS. 3 and 4 are diagrams showing methods for nodes of the wireless network groups to plan new transmission schedules;

FIG. 5 is a diagram showing wireless networks according to a second embodiment of the present invention; and

FIG. 6 is a diagram showing wireless networks according to a third embodiment of the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

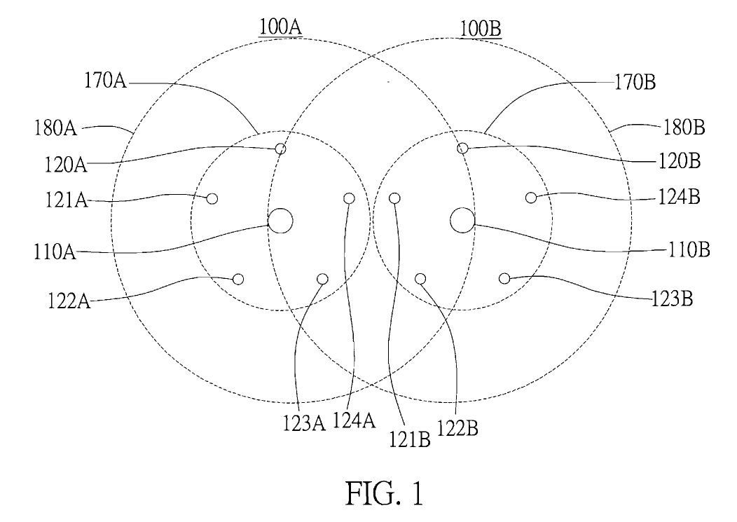

FIG. 1 is a diagram showing wireless networks according to a first embodiment of the present invention. As shown in FIG. 1, two wireless network groups 100A and 100b are provided, which comprise central processing nodes 110A and 110B, and a plurality of wireless sensor nodes 120A to 124A and 120B to 124B, respectively. Each of the central processing nodes 110A and 110B has a database for storing data, respectively. In the wireless network group 100A, the central processing node 110A communicates node information with the wireless sensor nodes 120A to 124A through a channel 170A with a narrow transmission range. Similarly, in the wireless network group 100B, the central processing node 110B communicates node information with the wireless sensor nodes 120B to 124B through a channel 170B with a narrow transmission range. Meanwhile, the central nodes 110A and 110B exchange group information with each other through channels 180A and 180B with a wide transmission range, respectively. The group information can be transmission schedule information or transmission demand information. Further, each of the central processing nodes may have a transmission schedule database, which is used to record transmission time and amount of transmission data of each node in the wireless network groups and also can be used to estimate required amount of transmission data.

In practice, first, the central processing node 110A exchanges transmission schedule information with the central processing node 110B through the channel 180A with a wide transmission range for forming new transmission schedule information. Next, the central processing node 110A coordinates resource allocation with the network nodes in the wireless network group 100A through the channel 170A with a narrow transmission range according to the new transmission schedule information, thereby preventing packet collisions between the two wireless network groups.

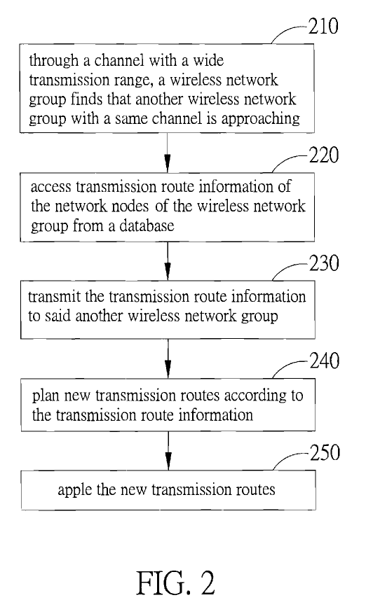

FIG. 2 is a flow diagram showing a method for preventing packet collisions when two wireless network groups are close to each other. At step 210, through the channel 180A with a wide transmission range, the central processing node 110A of the first wireless network group 100A finds that the second wireless network group 100B with a same channel is approaching. At step 220, the central processing node 110A of the first wireless network group 100A accesses transmission schedule information of the network nodes of the first wireless network group 100A from the database. At step 230, the central processing node 110A of the first wireless network group 100A transmits the transmission schedule information to the central processing node 110B of the second wireless network group 100B through the channel 180A before a package collision occurs, wherein the transmission schedule information comprises packet transmission time of each node in the wireless network groups using a channel with a narrow transmission range, or amount of transmission data of the nodes or required amount of transmission data. At step 240, after the transmission schedule information is shared between the wireless network groups, the nodes of the wireless network groups 100A, 100B jointly plan new transmission schedules according to the transmission schedule information so as to prevent packet collisions in the channel with a narrow transmission range. At step 250, the nodes of the wireless network groups 100A, 100B utilize the new transmission schedules so as to prevent packet collisions in the channel with a narrow transmission range.

In a preferred embodiment, the central processing node 110A of the first wireless network group 100A can exchange transmission demand information with the central processing node 110B of the second wireless network group 100B so as to form new transmission schedule information through a predefined judging mechanism, thereby preventing packet collisions. For example, when the central processing node 110A of the first wireless network group 100A has a demand for receiving and sending packet data, it actively sends transmission demand information to the central processing node 110B of the second wireless network group 100B. At this time, the central processing node 110B may also have a demand for receiving and sending packet data. As a result, the two central processing nodes can determine which one has priority to obtain resources through a judging mechanism. For example, each of the two central processing nodes randomly generates a number and the numbers generated by the two central processing nodes are compared such that the central processing node with the bigger number has priority to obtain the transmission resources.

In another preferred embodiment, the network nodes can actively send demand information to the central processing nodes for requesting allocation of transmission resources. For example, in a wireless body area network, each node transmits data to a central processing node with different frequencies. If each node is required to transmit data to the central processing node at a same time interval, it will cause a waste of energy. Therefore, in the present embodiment, if certain nodes have data transmission demands, they first transmit demand information to the central processing node such that the central processing node can adjust transmission schedules of the nodes according to their demands, thereby decreasing energy waste of a part of the node devices and extending their standby time.

In another preferred embodiment, the present invention provides a device for exchange of information (not shown in the drawings), which is applicable to a data exchange mechanism having a first wireless network group with a plurality of network nodes and at least a second wireless network group with a plurality of network nodes, wherein the device is a central processing node disposed in the first wireless network group, which exchanges group information with the second wireless network through a channel with a wide transmission range and further communicates node information with the network nodes of the first wireless network group through a channel with a narrow transmission range.

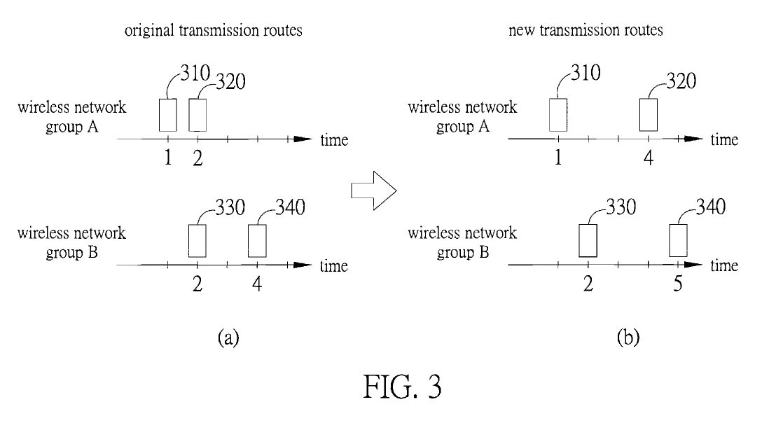

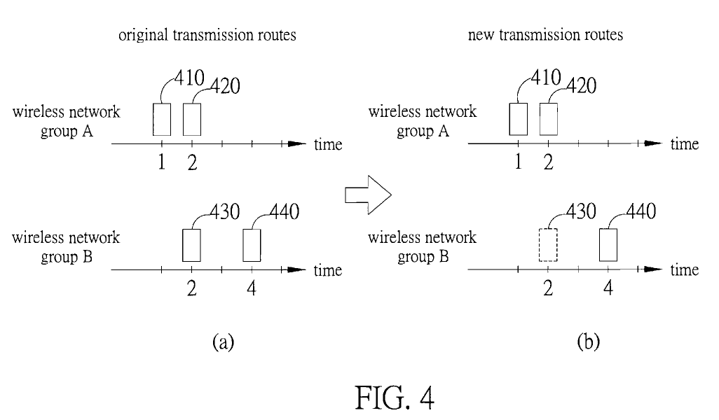

FIGS. 3 and 4 show methods for nodes of the wireless network groups to jointly plan new transmission schedules. In FIG. 3, packet collisions are prevented by alternating transmission time of the nodes. In FIG. 4, packet collisions are prevented by giving up transmission time point of the nodes. The above two methods can be used separately or used in combination. They are detailed as follows.

FIG. 3(a) shows original transmission schedules of the wireless network groups 100A and 100B. Therein, since a packet collision occurs at the second time point, new transmission schedules must be jointly planned. FIG. 3(b) shows a method of alternating the transmission time, wherein the first wireless network group 100A transmits a packet 310 at the first time point and then the second wireless network group 100B transmits a packet 330 at the second time point. Then, the first wireless network group 100A transmits a packet 320 at a next time point such as the fourth time point and then the second wireless network group 100B transmits a packet 340 at a next time point such as the fifth time point. Such an alternating way prevents packets from being transmitted at a same time so as to prevent packet collisions.

FIG. 4(a) shows original transmission schedules of wireless network groups 100A and 100B, wherein packet collisions occur at the second time point and accordingly new transmission schedules must be jointly planned. FIG. 4(b) shows a method of giving up transmission time point. Therein, the first wireless network group 100A transmits a packet 410 at the first time point and next the second wireless network group 100B gives up transmission of a packet 430 so as to allow the first wireless network group 100A to transmit a packet 420 at the second time point. Then, the wireless network groups 100A, 100B transmit respective packets at respective time points, for example, the wireless network group 100B transmits a packet 440 at the fourth time point. In such a way, packet collisions are prevented.

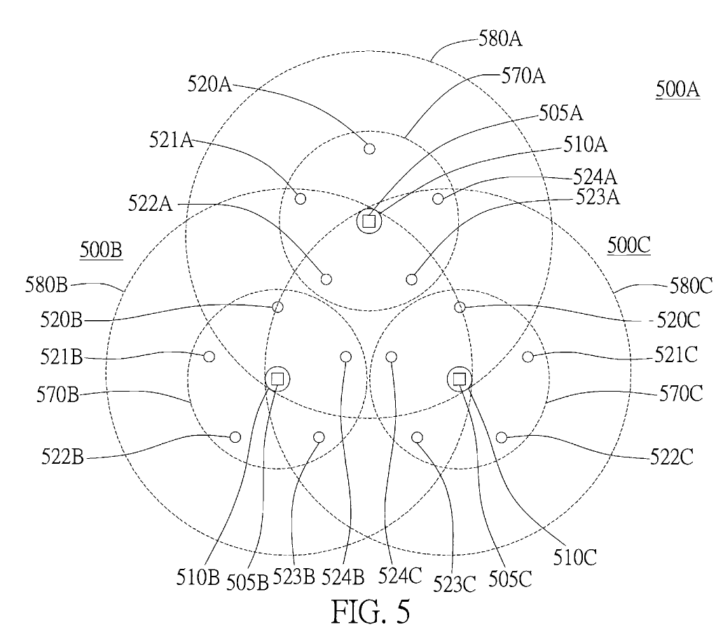

FIG. 5 is a diagram showing wireless networks according to a second embodiment of the present invention. It should be noted that the present invention exemplifies more than two wireless network groups, which however is not intended to limit the present invention. Three wireless network groups 500A, 500B, 500C have central processing nodes 510A, 510B, 510C and a plurality of wireless sensor nodes 520A to 524A, 520B to 524B, 520C to 524C, respectively. The central processing nodes 510A, 510B, 510C comprises databases 505A, 505B, 505C, respectively. In the wireless network group 500A, the central processing node 510A communicates with the wireless sensor nodes 520A to 524A through a channel 570A with a narrow transmission range. Similarly, in the wireless network groups 500B and 500C, the central processing nodes 510B, 510C communicate with the wireless sensor nodes 520B to 524B and 520C to 524C through channels 570B, 570C with a narrow transmission range, respectively. Meanwhile, the central processing nodes 510A, 510B, 510C communicate with each other through channels 580A, 580B, 580C with a wide transmission range, respectively. Further, the databases 505A, 505B, 505C are transmission schedule databases for recording transmission time and amount of transmission data of each node in the wireless network groups and can also be used to estimate required amount of transmission data.

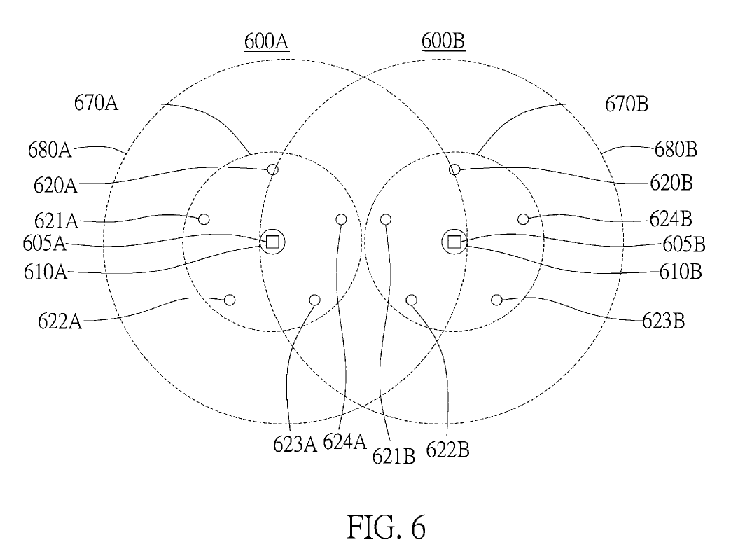

FIG. 6 is a diagram showing wireless networks according to a third embodiment of the present invention. FIG. 6 is similar to FIG. 1. Accordingly, similar elements in FIG. 6 are denoted by similar reference numerals and detailed description thereof is omitted. In FIG. 6, two wireless network groups 600A, 600B find each other in advance through channels 680A, 680B with a wide transmission range and jointly select one of the wireless network groups such as 600A as the master wireless network group. Through the channels with a wide transmission range, information about packet transmission time, amount of transmission data of each node, or required amount of transmission data of each node is transmitted by all the wireless network groups to the master wireless network group. Based on the information, the master wireless network group determines transmission schedules of wireless nodes of all the wireless network groups in channels such as 670A, 670B with a narrow transmission range, and further sends information of the transmission schedules to the wireless nodes of the wireless network groups. As a result, these new transmission schedules are applied to the wireless nodes so as to prevent collision in the channels with a narrow transmission range.

In the above-described three embodiments, the channel with a wide transmission range and the channel with a narrow transmission range are implemented on two different wireless systems, respectively, and a communication channel is established between the two wireless systems such that transmission schedule information can be communicated between the two wireless systems.

In addition, in the above-described three embodiments, the channel with a wide transmission range and the channel with a narrow transmission range can be implemented on a same wireless system, and the wireless system distinguishes the two channels through division along the time axis, frequency division or channel division achieved by different communication coding. In order to achieve division along the time axis, wireless nodes need to use an antenna amplifier capable of dynamically adjusting power or two antenna amplifiers with different power so as to form a channel with a wide transmission range and a channel with a narrow transmission range at different time points. In order to achieve frequency division, wireless nodes need to use an antenna amplifier capable of adjusting power according to frequency or two antenna amplifiers with different power so as to form a channel with a wide transmission range and a channel with a narrow transmission range at different frequencies. In order to achieve code division, wireless nodes generate two different coding signals during coding or use two antenna amplifiers with different power so as to form a channel with a wide transmission range and a channel with a narrow transmission range in different coding.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

What is claimed is:

1. A method for exchanging information between multiple wireless network groups, comprising:
providing a first wireless network group and at least a second wireless network group, wherein each of the first and second wireless network groups includes a central processing node and a plurality of network nodes; and
providing the central processing node of the first wireless network group through a first channel with a first transmission range to exchange group information with the central processing node of the second wireless network group that has a channel as same as the first channel, so as for the central processing node of the first wireless network group to communicates node information with the network nodes of the first wireless network group through a second channel with a second transmission range according to the group information, wherein the first transmission range is greater than the second transmission range.

2. The method of claim 1, wherein the group information is transmission schedule information, allowing the central processing node of the first wireless network group to exchange the transmission schedule information with the central processing node of the second wireless network group so as to form new transmission schedule information for preventing packet collisions.

3. The method of claim 1, wherein the group information is transmission demand information, allowing the central processing node of the first wireless network group to exchange the transmission demand information with the central processing node of the second wireless network group so as to form a new transmission schedule information for preventing packet collisions.

4. The method of claim 1, wherein the first channel with the first transmission range and the second channel with the second transmission range are implemented in different wireless systems.

5. The method of claim 4, wherein each of the central processing nodes comprises a communication interface for exchanging information between the first channel with the first transmission range and the second channel with the second transmission range.

6. The method of claim 1, wherein the first channel with the first transmission range and the second channel with the second transmission range are implemented in a same wireless system.

7. The method of claim 6, wherein the first and second wireless network groups distinguish the first channel with the first transmission range with the second channel with the second transmission range by a method selected from the group consisting of time division, frequency division and code division.

8. The method of claim 2, wherein the new transmission schedule information involves alternating packet transmission schedules of the network nodes so as to prevent packet collisions.

9. The method of claim 2, wherein the new transmission schedule information involves giving up packet transmission schedules of the network nodes for preventing packet collisions when the packet collisions are being occurred.

10. The method of claim 2, wherein the new transmission schedule information involves alternating packet transmission schedules of the network nodes and giving up packet transmission schedules of the network node so as to prevent packet collisions.

11. A system for exchanging information between multiple wireless network groups, comprising:
a first wireless network group with a central processing node and a plurality of network nodes; and
at least a second wireless network group with a central processing node and a plurality of network nodes,
wherein, through a first channel with a first transmission range, the central processing node of the first wireless network group exchanges group information with the central processing node of the second wireless network group that has a channel the same as the first channel so as for the central processing node of the first wireless network group to communicate node information with the network nodes of the first wireless network group through a second channel with a second transmission range according to the group information, the first transmission range being greater than the second transmission range.

12. The system of claim 11, wherein the group information is transmission schedule information, allowing the central processing node of the first wireless network group to exchange the transmission schedule information with the central processing node of the second wireless network group so as to form a new transmission schedule information for preventing packet collisions.

13. The system of claim 11, wherein the group information is transmission demand information, allowing the central processing node of the first wireless network group to exchange the transmission demand information with the central processing node of the second wireless network group so as to form a new transmission schedule information for preventing packet collisions.

14. The system of claim 11, wherein the first channel with the first transmission range and the second channel with the second transmission range are implemented in different wireless systems.

15. The system of claim 11, wherein the first and second wireless network groups which are implemented is a same system distinguish the first channel with the first transmission range with the second channel with the second transmission range that are implemented in a same wireless system by a method selected from the groups consisting of time division, frequency division and code division.

16. The system of claim 12, wherein the first wireless network group alternates packet transmission schedules of the network nodes so as to form the new transmission schedule information for preventing packet collisions.

17. The system of claim 12, wherein the first wireless network group allows giving up packet transmission schedules of the network nodes for preventing packet collisions when the packet collisions are being occurred.

18. A device for exchanging information between multiple wireless network groups, applicable to a data exchange mechanism having a first wireless network group with a plurality of network nodes and at least a second wireless network group with a plurality of network nodes, the device comprising:
a central processing node disposed in the first wireless network group for exchanging a group information with the second wireless network group through a channel with a first transmission range and further communicating node information with the network nodes of the first wireless network group through a channel with a second transmission range, wherein the first transmission range is greater than the second transmission range.

19. The device of claim 18, wherein the group information is transmission schedule information, allowing the central processing node of the first wireless network group to exchange the transmission schedule information with the second wireless network group so as to form a new transmission schedule information for preventing packet collisions.

20. The device of claim 18, wherein the group information is transmission demand information, allowing the central processing node of the first wireless network group to exchange the transmission demand information with the second wireless network group so as to form a new transmission schedule information for preventing packet collisions.

21. The device of claim 18, wherein the first channel with the first transmission range and the second channel with the second transmission range are implemented in different wireless systems.

22. The device of claim 18, wherein the first and second wireless network groups that are implemented in a same wireless system distinguish the first channel with the first transmission range from the second channel with the second transmission range by a method selected from the group consisting of time division, frequency division and code division.

23. The device of claim 18, wherein the first wireless network group alternates packet transmission schedules of the network nodes so as to form new transmission schedule information for preventing packet collisions.

24. The device of claim 18, wherein the first wireless network group allows giving up packet transmission schedules of the network nodes for preventing packet collisions when the packet collisions are being occurred.
